(19) United States
(12) Patent Application Publication
(10) Pub. No.: US 2013/0319941 A1
(43) Pub. Date: Dec. 5, 2013

(54) SIMULTANEOUS RECOVERY OF COAGULANT AND ACID

(71) Applicant: ORREN D. SCHNEIDER, Plainsboro, NJ (US)

(72) Inventor: ORREN D. SCHNEIDER, Plainsboro, NJ (US)

(73) Assignee: AMERICAN WATER WORKS COMPANY, INC., VOORHEES, NJ (US)

(21) Appl. No.: 13/489,254

(22) Filed: Jun. 5, 2012

(51) Int. Cl. C02F 1/42; C02F 1/58; C02F 1/68

(52) U.S. Cl. 210/638; 210/206

(57) ABSTRACT

Processes and systems are provided for simultaneously recovering coagulant and acid in a water treatment system. Sludge produced by the water treatment system is contacted with acid to form acidified solids. The acidified solids flow into a combined membrane treatment tank having both cation and anion exchange membranes. Metal cations from the acidified solids cell diffuse across the cation exchange membranes to form recovered coagulant, while anions from the acidified solids diffuse across the anion exchange membranes to form recovered acid. The diffusion rate of the metal cations across the cation exchange membranes may be equal to or greater than the diffusion rate of the anions across the anion exchange membranes.

The chemicals required in a water treatment plant may include chlorine, caustic, phosphates, lime/soda ash, fluoride, coagulants, and several others. Of these, the coagulants, such as alum, ferric chloride, or ferric sulfate, typically account for the largest portion of spending among these chemicals. Additionally, the used coagulants from a water treatment plant add to the amount of residuals that must be disposed of, which adds more cost to the total waste disposal cost of the plant. Coagulation is a process that provides for the removal of solids from the water, especially colloidal or very small particles. Additionally, organic matter and dissolved heavy metals are also removed by coagulation. Generally, coagulant chemicals are used to neutralize the electrical charges of the fine particles in the water, allowing the particles to move closer together and form larger clumps, which are then removed in the treatment process. When coagulant recovery is attempted in a drinking water treatment plant, acid is needed, which in addition to dissolving the precipitated coagulants can also solubilize the removed organic matter and heavy metals. The acid also counteracts the cost savings of recovering the coagulant. Because of these potential issues, coagulant recovery is rarely performed in drinking water treatment plants in the United States.

### SUMMARY

Embodiments of the invention are defined by the claims below, not this summary. A high-level overview of various aspects of the invention are provided here for that reason, to provide an overview of the disclosure, and to introduce a selection of concepts that are further described in the detailed description section below. This summary is not intended to identify key features or essential features of the claimed subject matter, nor is it intended to be used as an aid in isolation to determine the scope of the claimed subject matter. In brief and at a high level, this disclosure describes, among other things a process and system for simultaneously recovering coagulant and acid used in a water treatment system. Coagulant is used in the plant, and once used, is found in the sludge from the plant. In order to mobilize the coagulant when recovering the coagulant, acid is used to acidify the sludge solids. Coagulant recovery without acid recovery, in some instances, may not save enough money to make the recovery efforts economically worthwhile, which is why acid recovery is also involved in the simultaneous recovery process described herein. Further, a separate acid recovery process also has many drawbacks, including having two separate tanks for coagulant and acid recovery and having to transport materials containing acid to different locations in the water treatment plant. As such, having a single membrane treatment tank that both recovers acid and coagulant simultaneously has many significant advantages, which will become more apparent as the processes and systems are described below. Water treatment plant or system, as used herein, may refer to a wastewater treatment plant (e.g., industrial wastewater treatment plant) or a drinking water treatment plant.

### BRIEF DESCRIPTION OF THE SEVERAL VIEWS OF THE DRAWINGS

Illustrative embodiments of the present invention are described in detail below with reference to the attached drawing figures, and wherein:

FIG. 1 illustrates a process flow diagram of a portion of a water treatment system, in accordance with an embodiment of the present invention;

FIG. 2 illustrates a process flow diagram of a combined membrane treatment tank for simultaneously recovering acid and coagulant, in accordance with an embodiment of the present invention;

FIG. 3 illustrates a schematic diagram of a simultaneous coagulant and acid recovery process, in accordance with an embodiment of the present invention; and

FIGS. 4 and 5 are flow diagrams illustrating methods for simultaneously recovering coagulant and acid from acidified (dissolved) solids, in accordance with embodiments of the present invention.

### DETAILED DESCRIPTION

The subject matter of embodiments of the present invention is described with specificity herein to meet statutory requirements. But the description itself is not intended to necessarily limit the scope of claims. Rather, the claimed subject matter might be embodied in other ways to include different steps or combinations of steps similar to the ones described in this document, in conjunction with other present or future technologies. Terms should not be interpreted as implying any particular order among or between various steps herein disclosed unless and except when the order of individual steps is explicitly described.

In a first aspect of the present invention, a process is provided for simultaneously recovering coagulant and acid in a water treatment system. The process includes contacting sludge from a water treatment system with acid to produce acidified solids, and flowing the acidified (dissolved) solids into a combined membrane treatment tank that comprises cation exchange membranes and anion exchange membranes to simultaneously recover the coagulant and the acid from the acidified solids. Metal cations diffuse across the cation exchange membranes and the anions diffuse across the anion exchange membranes to form a recovered coagulant stream and a recovered acid stream. The diffusion rate of the metal cations across the cation exchange membranes is equal to or greater than the diffusion rate of the anions across the anion exchange membranes.

In a second aspect of the present invention, a process is provided for simultaneously recovering coagulant and acid in a water treatment system. The process includes, upon utilizing the coagulant in the water treatment system where sludge is produced, mixing the sludge in a mixing tank with acid to produce waste solids and acidified solids. The acid is one or more of new acid or recovered acid, and the coagulant is one of an aluminum coagulant or an iron coagulant. Further, the process includes, in a combined membrane treatment tank having cation exchange membranes and anion exchange membranes, recovering aluminum or iron ions as they diffuse across the cation exchange membranes into an acid solution cell and react with a sulfuric acid solution or a hydrochloric acid solution to form recovered coagulant. Further, the process includes recovering anions as they diffuse across the anion exchange membranes into a water cell to form the recovered acid.

In a third aspect of the present invention, a system is provided for simultaneously recovering coagulant and acid in a water treatment system. The system includes a mixing tank that receives and mixes sludge from the water treatment system and a first acid stream to form acidified solids and waste solids, the first acid stream being recovered acid or new acid. The system further includes a combined membrane treatment tank that receives the acidified solids from the mixing tank, water, and a second acid stream to form the recovered acid and recovered coagulant. The combined membrane treatment tank is used to simultaneously recover the coagulant from the acidified solids and at least a portion of the first acid stream, and the diffusion rate of metal cations across cation exchange membranes in the combined membrane treatment tank is equal or greater than the diffusion rate of anions across the anion exchange membranes in the combined membrane treatment tank.

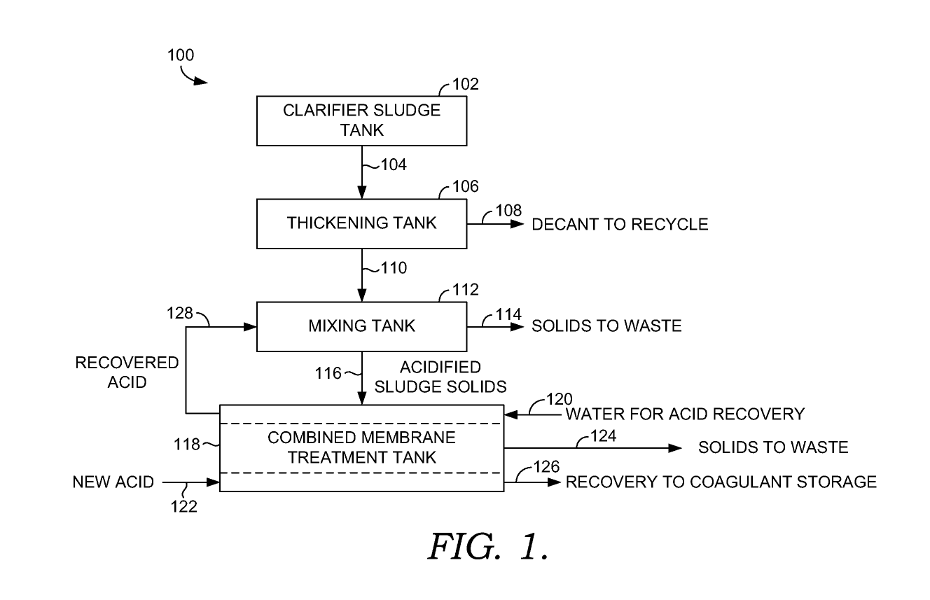

Referring to the drawings in generally and initially to FIG. 1, FIG. 1 illustrates a process flow diagram 100 of a portion of a water treatment system, in accordance with an embodiment of the present invention. Water treatment plant or system, as used herein, may refer to a wastewater treatment plant (e.g., industrial wastewater treatment plant) or a drinking water treatment plant. The process flow diagram 100 represents just a portion of a water treatment plant that intakes water and outputs clean water that can be reused. It should be noted that while four tanks are illustrated in the embodiment of FIG. 1, there may be more or less tanks used to accomplish embodiments of the present invention described herein, which include to simultaneously recover coagulant used in the water treatment plant and recover acid used to recover the coagulant. The portion illustrated in FIG. 1 begins with a clarifier sludge tank 102 that intakes sludge from the water treatment plant and clarifies it. The output of this tank is clarified sludge 104, which flows into a thickening tank 106. The thickening tank 106 thickens the clarified sludge 104 by extracting water out of the clarified sludge, which is the decant stream 108 that may be recycled. Decant, generally, is the liquid that is separated from the stream that includes the solids, which, here, is the thickened sludge 110. The thickened sludge 110 flows into a mixing tank 112 where acid 128 is mixed with the thickened sludge 110. The acid dissolves a majority of the thickened sludge. In one instance, the mixing tank 112 is an acid resistant tank. In one embodiment, the acid 128 is recovered acid from the process described herein, but in another embodiment, the acid 128 is new acid that has not previously been used in the plant. Typically, when alum is used as the coagulant, sulfuric acid is used to acidify the solids. When ferric chloride is used as the coagulant, hydrochloric acid is used to acidify the solids. Similarly, when ferric sulfate is used as the coagulant, sulfuric acid is used as the acid. As such, either sulfuric acid or hydrochloric acid is recovered in the process described herein.

Aluminum coagulants are typically purchased as commercial grade alum (aluminum sulfate), which is manufactured commercially by several methods often by reacting aluminum hydroxide (sometimes in the form of high alumina clays such as kaolin or bauxite) with sulfuric acid, according to the formula below:

2Al(OH)₃+3H₂SO₄+xH₂O→Al₂(SO₄)₃·(6+x)H₂O

Iron coagulants are typically in the form of ferric chloride or ferric sulfate. Commercial grade ferric chloride is manufactured by the exothermic reaction between ferric oxide and hydrochloric acid, according to the formula below:

Fe₂O₃+6HCl→3H₂O+2FeCl₃

Or, alternatively, by dissolving iron ore in hydrochloric acid, according to the formula below:

Fe₃O₄+8HCl→FeCl₂+2FeCl₃+4H₂O

Another iron coagulant that may be used is ferric sulfate, which is produced on a large scale by reacting sulfuric acid, a hot solution of ferrous sulfate, and an oxidizing agent (such as nitric acid or hydrogen peroxide), according to the formula below:

6FeSO₄+3H₂SO₄+2HNO₃→3Fe₂(SO₄)₃+4H₂O+2NO

Various coagulant recovery methods have been tested and used in the past, but due to the relatively low cost of the commodity materials (alum or ferric salts) and required capital expenditures, it has not been widely used. Coagulant recovery is generally based on dissolution of the sludge and may or may not be followed by a purification step. The dissolution of sludge is based on the solubility of aluminum (or iron) hydroxide residuals at either low or high pH. Alkalization, acidification, liquid ion exchange, and resin-based ion exchange are just a few of the methods that have been tested and used in the past.

Returning to FIG. 1, acidified (dissolved) solids 116 are produced in the mixing tank 112 and flow to a combined membrane treatment tank 118, which includes both cation and anion exchange membranes. The cation exchange membranes allow the trivalent aluminum ions to pass through to the other side, thus recovering the coagulant. This step can be explained by the term Donnan dialysis. Donnan dialysis, also called diffusion dialysis, operates on the basis of an ion exchange membrane. Unlike other commonly used membrane processes (e.g., microfiltration or reverse osmosis), Donnan dialysis does not operate on the basis of pressure differential, but rather operates based on differences in electrochemical potential. The electrochemical potential of an ion in solution is essentially based on the charge and concentration of the ion. This is formally expressed as:

μᵢ=μᵢ⁰+RTLnaᵢ+zᵢFφ

Where μᵢ is the chemical potential of any species, i, in solution; the superscript 0 denotes the standard state; aᵢ is the activity of the species; zᵢ is the valency of the ion; F is the Faraday Constant; R is the ideal gas constant; T is the absolute temperature, and φ is the electrical potential

At equilibrium, the electrochemical potential of ions on either side of the membrane will be the same. Under non-equilibrium conditions, ions will migrate in order to achieve the equilibrium condition.

If an ionic solution is divided by a cation exchange membrane that allows only cations to pass, cations will permeate from one side of the membrane to the other. In order to maintain electroneutrality on both sides of the membrane, protons (hydrogen ions) will counter-permeate. Thus, at equilibrium, the following expression holds:

$$( \frac{{C}_{M}^{F}}{{C}_{M}^{S}} ) = {( \frac{{C}_{H}^{F}}{{C}_{H}^{S}} )}^{Z}$$

where C is the molar concentration of a metal, M, and hydrogen, H, respectively. Z is the valency of the metal ion (+2 for zinc, +3 for aluminum), and F and S are the feed and sweep sides of the membrane.

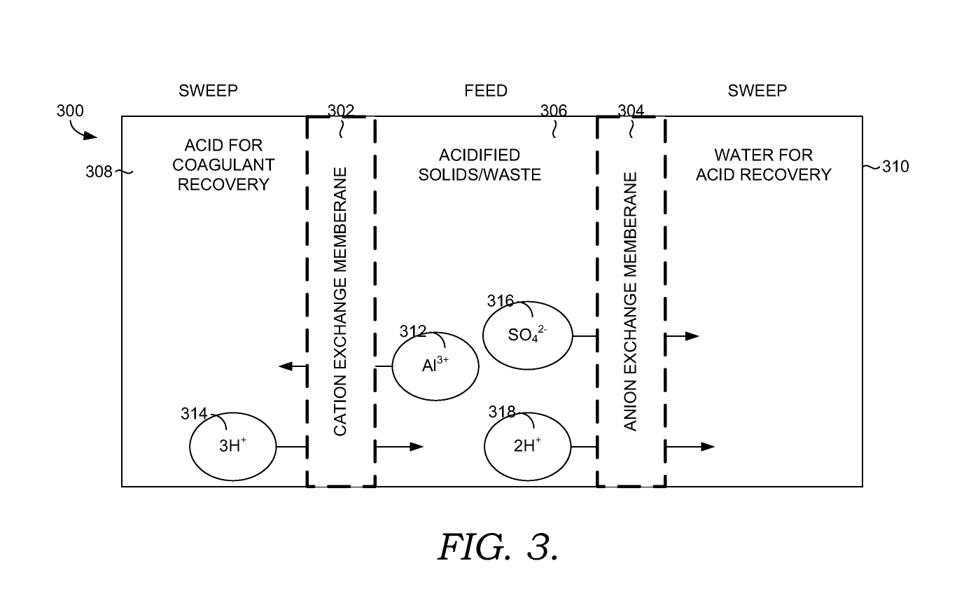

Because a cation exchange membrane is used, negatively charged species such as sulfate or natural organic matter (NOM) are excluded from crossing the membrane. Protozoan contaminants such as Cryptosporidium oocysts or Giardia cysts being negatively charged above pH 3 are also prevented from crossing the membrane. Thus, a high degree of purification is achieved. When applied to coagulant recovery, sludge would be acidified using sulfuric acid to liberate aluminum (or iron, if used) from the hydroxide precipitate. The liquid would be decanted into a membrane tank (or stack) containing a cation exchange membrane with dilute acid on the permeate side, also called the sweep. The free coagulant would then be allowed to diffuse into the sweep acid. This is illustrated in FIG. 3, which will be discussed in more detail below.

In essence, the equation above states that if the molar ratio of acid on the two sides of the membrane is 10 (a pH difference of 1.0 unit), then the molar aluminum ratios at equilibrium will be 1000 (10³). Larger pH differences will result in greater driving forces. Thus, by maintaining a difference in pH across the membrane, aluminum diffuses, even from a low concentration into a high concentration. Importantly, divalent cations (such as a number of heavy metals including zinc and copper) will diffuse to a lesser extent (10²), reducing contamination of the recovered alum or iron coagulant.

The concentration of the aluminum in the recovered alum would be dependent on the kinetics of the exchange (based on the diffusion of aluminum through the membrane) as well as the volume and concentration of the acid sweep. Bench testing of the system performed by scientists and researchers in the field has shown an aluminum recovery in excess of 70%. Experiments with iron showed ferric ion recovery of 75%.

Once again in reference to FIG. 1 and as discussed above, the coagulant (e.g., trivalent aluminum ions or iron) diffuses through the cation exchange membranes and into a sweep solution (e.g., diluted acid) of either sulfuric acid or hydrochloric acid (depending on the coagulant). The purified material, or recovered coagulant 126, can then be reused as coagulant in the water treatment plant. In the process of coagulant recovery as described above, the residual stream becomes more highly acidified. The acid is then recovered on the alternating side through anion exchange membranes into a sweep solution of potable water. The overall reduction in solids may be between 40-50%. This, along with the acid and coagulant recovery, provides for reduced overall plant operation costs by reducing the amount of coagulant that needs to be purchased. Additionally, the quantity of residuals that are removed from the site and disposed of is also greatly reduced. The recovered acid, for instance, may be used to acidify more sludge. The final residuals (solids), or waste solids 124, are neutralized with lime in one embodiment, and are disposed of accordingly. Along with acid 122, water 120, such as potable water, is used for the acid recovery process within the combined membrane treatment tank. In one embodiment, the acid 122 added to the combined membrane treatment tank 118 is new acid, but in another embodiment, it is recovered acid from the acid recovery process described herein.

As mentioned, the anion exchange membranes in the combined membrane treatment tank 118 use ion exchange to remove acid anions (e.g., sulfate or chloride) while rejecting divalent cations (e.g., metals) and larger organics. Unlike the coagulant recovery process described above, however, there is a net transfer from the sweep solution. In addition to the acid anion transfer, in order to maintain electroneutrality, protons also transfer from the feed side into the sweep. Thus, up to 90% of the acid used to solubilize the sludge may be recovered. As described herein, the combined membrane treatment tank is a single tank that simultaneously recovers acid and coagulant. There are numerous advantages of simultaneously recovering acid and coagulant in a single tank, such as not having to transport acid from one tank to another, and having all of the membranes in a single tank. It is also a more efficient process to simultaneously recover the acid and coagulant in a single tank. Fewer pumps, tanks, valves, pipes, etc. are needed in the plants.

As will be discussed in more detail herein, the combined membrane treatment tank 118 includes alternating cationic and anionic exchange membranes that are arranged to allow the aluminum (or acid) and acid recovery process to occur simultaneously such that the aluminum or iron diffuses into one stream and the sulfate or chloride and hydrogen ions diffuse into a second stream. This combined process results in a smaller footprint and reduced tankage and pumpage. As such, fewer and perhaps smaller pumps may be needed, and transporting acid to different tanks becomes less of an issue, as the tanks are combined into the combined membrane treatment tank 118. In order to maintain a balance in the diffusion of hydrogen ions, in addition to preventing precipitation of metals in the sludge, the membranes may have nearly identical aluminum or iron and sulfate or chloride diffusion rates. In one embodiment, the aluminum or iron has a higher diffusion rate than the sulfate or chloride, but in another embodiment, the diffusion rates are approximately equal. If the sulfate or chloride has a higher diffusion rate than the aluminum or iron, the pH may increase resulting in solid precipitation.

Generally, the combined membrane treatment tank 118, as mentioned has alternating cation and anion exchange membranes. In one embodiment, the order of cells may be a water/acid cell, an acidified solids/waste cell, an acid/coagulant cell, an acidified solids/waste cell, and a water/acid cell. As such, the order of membranes in this embodiment is an anion exchange membrane, two cation exchange membranes, and then another anion exchange membrane. This order of cells and membranes may continue multiple times, and collectively, this is referred to as the combined membrane treatment tank 118. In another embodiment, one combined membrane treatment tank 118 may be used, but once the metal cations diffuse through the cation exchange membranes and react with acid, the remaining acidified material is placed in another portion of the membrane treatment tank where the material diffuses through an anion exchange membrane to recover acid. The recovered acid may be used for acidifying new sludge from the water treatment plant. What remains of the acidified sludge is neutralized, such as with lime, prior to disposal.

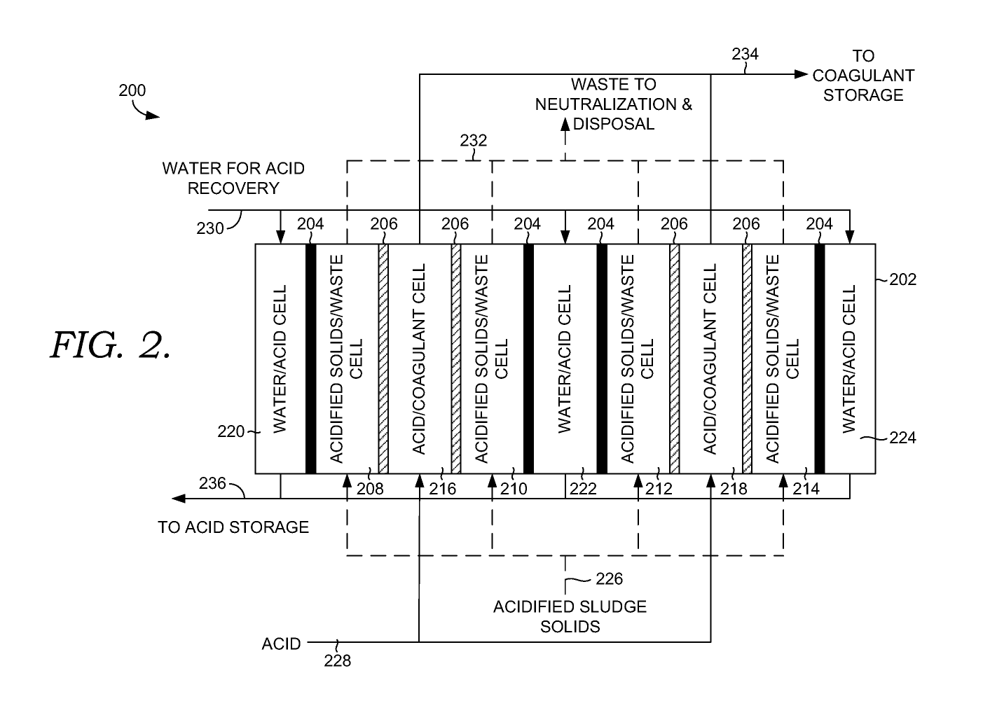

Turning now to FIG. 2, a process flow diagram 200 illustrates a combined membrane treatment tank for simultaneously recovering acid and coagulant, in accordance with an embodiment of the present invention. The combined membrane treatment tank 202 contains both cation and anion exchange membranes. The cation exchange membranes 206 allow for the aluminum or iron to pass through to the acid/coagulant cells 216 and 218, but do not allow the acid (e.g., sulfate or chloride ions) to pass through, thus allowing for the recovery of the materials used for the coagulant in the water treatment plant. The anion exchange membranes 204, on the other hand, allow the acid (e.g., sulfate or chloride ions) to pass through to the water/acid cells 220, 222, and 224, but do not allow the aluminum or iron ions to pass through, thus allowing for the recovery of the acid used both to acidify the sludge and the acid added to the combined membrane treatment tank 202, as will be further discussed herein.

The combined membrane treatment tank 202 contains various cells, including acidified solids/waste cells 208, 210, 212, and 214, acid/coagulant cells 216 and 218, and water/acid cells 220, 222, and 224. While the cells mentioned above are illustrated in FIG. 2, the arrangement of cation/anion exchange membranes and of the various cells is just one embodiment of the invention, as alternative arrangements may also be used to carry out other embodiments of the present invention. The input to the acidified solids/waste cells 208, 210, 212, and 214 is the acidified sludge solids 226. As previously mentioned, sludge from the water treatment plant may first be clarified, thickened, and mixed with acid to form acidified sludge, as shown in FIG. 1 herein. This sludge then enters the combined membrane treatment tank 202 into the acidified solids/waste cells 208, 210, 212, and 214. As mentioned, the aluminum or iron from the acidified sludge solids 226 passes through the cation exchange membranes 206 to the acid/coagulant cells 216 and 218, as the sulfate or chloride passes through the anion exchange membranes 204 into the water/acid cells 220, 222, and 224. The waste or solids 232 that is not recovered exits the acidified solids/waste cells 208, 210, 212, and 214 and is neutralized (e.g., with lime) and properly disposed of. Using the processes and systems described herein, the amount of waste that is disposed of is greatly reduced because of the coagulant and acid recovery.

Acid 228 enters the combined membrane treatment tank 202 by way of the acid/coagulant cells 216 and 218. The acid 228 in these cells reacts with the aluminum or iron that has passed through the cation exchange membranes 206 to produce coagulant 234, as the aluminum or iron reacts with the acid. The type of acid used (e.g., sulfuric acid or hydrochloric acid) depends on the type of coagulant used in the water treatment plant. For example, an aluminum-based coagulant (e.g., alum) reacts with sulfuric acid, while an iron-based coagulant (e.g., ferric chloride) reacts with hydrochloric acid. Additionally, if ferric sulfate is the coagulant used in the plant, sulfuric acid is used. In one embodiment, alum is the coagulant used in the water treatment plant. In this case, trivalent aluminum ions (Al³⁺), as mentioned, pass through the cation exchange membranes 206 from the acidified solids/waste cells 208, 210, 212, and 214 to the acid/coagulant cells 216 and 218. Three hydrogen ions pass through the cation exchange membranes 206 the opposite way, or from the acid/coagulant cells 216 and 218 to the acidified solids/waste cells 208, 210, 212, and 214. This creates a net gain of aluminum in the acid/coagulant cells 216 and 218 and a net gain of one proton in each of the acidified solids/waste cells 208, 210, 212, and 214, as will be discussed further herein. The recovered coagulant 234 that exits the combined membrane treatment tank 202 through the acid/coagulant cells 216 and 218 is taken to coagulant storage so that it can be reused in the water treatment plant.

Water 230, such as, for example, potable water, enters the combined membrane treatment tank 202 by way of one of the water/acid cells 220, 222, and 224. As mentioned, the sulfate or chloride passes through the anion exchange membranes 204 and enters the water/acid cell 220, 222, or 224. In addition, two hydrogen ions also pass through the anion exchange membrane into the water/acid cell 220, 222, or 224, which is how there is a net gain of one proton in each of the acidified solids/waste cells 208, 210, 212, and 214. This will become more apparent during the discussion of FIG. 3 below. As such, there is a net gain of sulfate or chloride and the hydrogen ions (protons) in the water/acid cells 220, 222, and 224.

Turning to FIG. 3, a schematic diagram of a simultaneous coagulant and acid recovery process is illustrated, in accordance with an embodiment of the present invention. Initially, the combined membrane treatment tank, referred to as numeral 300, includes both cation and anion exchange membranes. The cation exchange membrane 302, as mentioned, allows for either aluminum (in the form of trivalent aluminum ions) 312 or iron to pass through from the cell containing the acidified solids/waste 306 to the cell containing acid for coagulant recovery 308. The cell containing the acidified solids/waste 306 has had the acidified sludge solids added to it, and the waste, or the sludge not recovered in this process, exits this cell and may be neutralized and properly disposed. The cell containing acid for coagulant recovery 308 has had acid (e.g., sulfuric acid or hydrochloric acid) added to it to react with the aluminum or iron to produce the recovered coagulant. As such, as shown here, three hydrogen ions (protons) 314 pass through the cation exchange membrane 302 in the opposite direction as the aluminum 312 into the cell containing the acidified solids 306.

Because the feed to the cell containing the acidified solids waste 306 contains acid, the sulfate 316 or chloride from this cell passes through the anion exchange membrane 304 to the cell containing water for acid recovery 310. Water is fed into this cell, and recovered acid exits this cell. In addition to the sulfate 316 or chloride passing through the anion exchange membrane 304, two hydrogen ions (protons) 318 also pass through the anion exchange membrane 304 into the cell containing the water for acid recovery 310. As such, the cell containing acid for coagulant recovery 308 has a net gain of aluminum, the cell containing the acidified solids/waste 306 has a net gain of one hydrogen ion (proton), and the cell containing water for acid recovery 310 has a net gain of sulfate or chloride and two hydrogen ions (protons). While the embodiment of FIG. 3 uses alum as the coagulant (e.g., aluminum diffuses through cation exchange membrane and sulfate diffuses through anion exchange membrane), the same process would be applicable for different coagulants, such as coagulants containing iron instead of aluminum. As mentioned, the type of acid may be different, but the overall process would operate in a similar manner to that shown in FIG. 3.

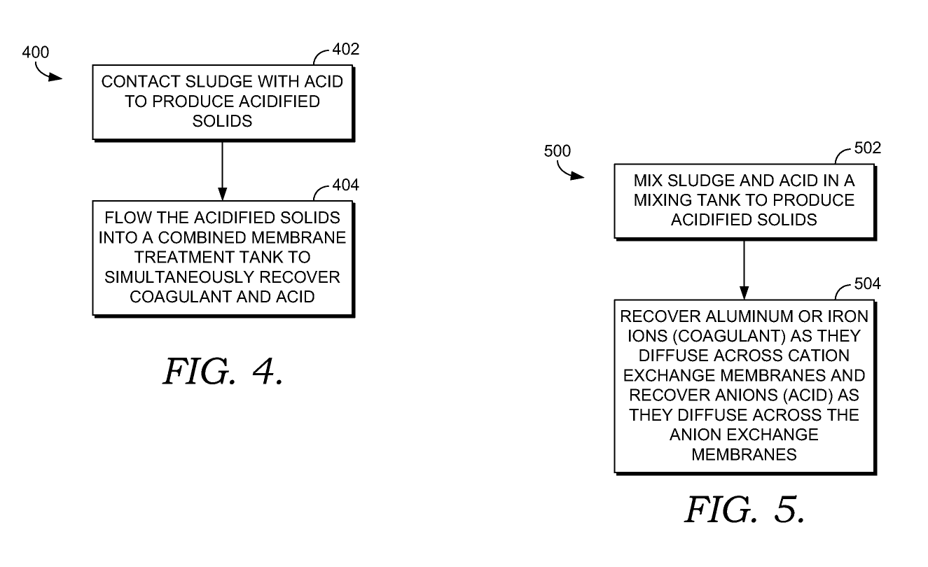

FIG. 4 is a flow diagram illustrating a method 400 for simultaneously recovering coagulant and acid from acidified solids, in accordance with an embodiment of the present invention. Initially, at step 402, sludge from a water treatment system or plant is contacted with acid to produce acidified solids. The type of acid used to acidify the sludge depends on the coagulant used in the water treatment plant. For instance, if the coagulant is aluminum based, such as alum, sulfuric acid may be used, as it reacts with aluminum. Similarly, ferric sulfate coagulant reacts with sulfuric acid. However, when a coagulant, such as ferric chloride, is used, hydrochloric acid may be used, as it reacts with ferric chloride. The acidified solids, at step 404, flow into a combined membrane treatment tank to simultaneously recover coagulant and acid. The recovered coagulant may be used in the water treatment plant. The recovered acid may be used to acidify the sludge from the plant.

The combined membrane treatment tank has both cation exchange membranes and anion exchange membrane so that the acid and coagulant from the acidified solids can simultaneously be recovered by this process. Recovering coagulant from a water treatment plant without recovering the acid used to acidify it (e.g., to mobilize the coagulant) is not cost effective, as the savings of recovering coagulant typically does not outweigh the cost of the acid needed to recover the coagulant, as acid is needed in the coagulant recovery process. Metal cations (e.g., trivalent aluminum ions or iron ions) diffuse across the cation exchange membranes to form a recovered coagulant stream, and anions (e.g., sulfates or chlorides) diffuse across the anion exchange membranes to form a recovered acid stream. As used herein, metal cations are positively charged metal ions, or solubilized metals, that are able to diffuse across the cation exchange membranes into an acid solution or an acid sweep such that the metal cations are able to react with the acid, or a component thereof, to form recovered coagulant. Anions, as used herein, are negatively charged compounds from the acidified solids that diffuse across the anion exchange membranes into a water solution such that the anions react with the water, or a component thereof, to form recovered acid. Further, in order to prevent solids precipitation of the acidified solids, the diffusion rate of the metal cations across the cation exchange membranes is equal to or greater than the diffusion rate of the anions across the anion exchange membrane. If sulfuric acid is the acid used to acidify the solids and to recover the coagulant, sulfate may be the ion that passes through the anion exchange membranes. The diffusion rate of the sulfate across the anion exchange membranes should be less than or equal to the diffusion rate of the metal cations that diffuse across cation exchange membranes.

As mentioned, when the metal cations diffuse across the cation exchange membranes, they react with the acid to form the recovered coagulant stream. When the anions diffuse across the anion exchange membranes, the anions combine with hydrogen ions (protons) in the water to form the recovered acid stream. In one embodiment, the input streams into the combined membrane treatment tank include the acidified solids, water for acid recovery, and acid for forming the recovered coagulant stream. Waste solids that are not recovered, the recovered coagulant stream, and the recovered acid stream are the output streams from the combined membrane treatment tank.

Referring now to FIG. 5, a flow diagram is depicted illustrating a method 500 for simultaneously recovering coagulant and acid from acidified solids, in accordance with an embodiment of the present invention. At step 502, the method includes mixing sludge and acid in a mixing tank to produce acidified solids. The sludge is produced from utilizing coagulant in the water treatment plant. The acid, in one embodiment is new acid, or acid not recovered using the process described herein. In another embodiment, the acid is recovered acid. Further, the coagulant may be an aluminum-based coagulant (e.g., alum) or an iron-based coagulant (e.g., ferric sulfate or ferric chloride).

At step 504, aluminum or iron is recovered as they diffuse across cation exchange membranes. If the metal cation is aluminum, trivalent aluminum ions diffuse across the cation exchange membrane into an acid solution cell and react with a sulfuric acid solution to form a recovered coagulant stream. Here, the coagulant may be alum. The recovered alum coagulant may be reused in the water treatment system. If the metal cation is iron, the iron ions diffuse across the cation exchange membrane into an acid solution cell and react with a hydrochloric acid solution to form a recovered acid stream. Anions are recovered as they diffuse across the anion exchange membranes into a water cell to form a recovered acid stream. The diffusion rates of the metal cations (e.g., aluminum or iron) and the anions (e.g., sulfates or chlorides) across the membranes may be approximately equal, in one embodiment. In an alternative embodiment, the diffusion rate of the metal cations may be greater than the diffusion rate of the anions. If the diffusion rate of the anions is greater than the diffusion rate of the metal cations, the solids in the acidified solids may precipitate, which should be avoided.

It should be noted that while embodiments of the present invention described herein are described with respect to aluminum and iron coagulants used in a water treatment plant, other chemical formulations or waste streams from other processes other than water treatment plants may be used in the systems described herein. For instance, industries other than water may utilize coagulants or other chemical products that may be recovered using embodiments described herein. Also, whether alum, an iron coagulant, or any other coagulant is used in the plant, the process of recovering coagulant and acid described herein can be used.

Many different arrangements of the various components depicted, as well as components not shown, are possible without departing from the scope of the claims below. Embodiments of the technology have been described with the intent to be illustrative rather than restrictive. Alternative embodiments will become apparent to readers of this disclosure. Further, alternative means of implementing the aforementioned can be completed without departing from the scope of the claims below. Certain features and subcombinations are of utility and may be employed without reference to other features and subcombinations and are contemplated within the scope of the claims.

The invention claimed is:

1. A process for simultaneously recovering coagulant and acid in a water treatment system, the process comprising:
contacting sludge from a water treatment system with acid to produce acidified solids;
flowing the acidified solids into a combined membrane treatment tank that comprises cation exchange membranes and anion exchange membranes to simultaneously recover the coagulant and the acid from the acidified solids such that metal cations diffuse across the cation exchange membranes to form a recovered coagulant stream and the anions diffuse across the anion exchange membranes to form a recovered acid stream, wherein a diffusion rate of the metal cations across the cation exchange membranes is equal to or greater than the diffusion rate of the anions across the anion exchange membranes.

2. The process of claim 1, wherein the recovered acid stream and the recovered coagulant stream can be used to treat the sludge from the water treatment system.

3. The process of claim 1, wherein the metal cations combine with acid anions to form the recovered coagulant stream.

4. The process of claim 1, wherein the anions combine with hydrogen ions to form the recovered acid stream.

5. The process of claim 1, wherein the metal cations are positively charged metal ions that react with an acid to form the recovered coagulant stream that is reused in the water treatment system.

6. The process of claim 1, wherein the coagulant is alum such that the metal cations are trivalent aluminum ions, the anions are sulfates, and the recovered acid stream is sulfuric acid.

7. The process of claim 1, wherein the coagulant is ferric chloride such that the metal cations are iron ions, the anions are chlorides, and the recovered acid stream is hydrochloric acid.

8. The process of claim 1, wherein the coagulant is ferric sulfate such that the metal cations are iron ions, the anions are sulfates, and the recovered acid stream is sulfuric acid.

9. The process of claim 1, wherein the acidified solids, water for acid recovery, and acid for forming the recovered coagulant stream are input streams into the combined membrane treatment tank and waste solids, the recovered coagulant stream, and the recovered acid stream are the outputs from the combined membrane treatment tank.

10. A process for simultaneously recovering coagulant and acid in a water treatment system, the process comprising:
upon utilizing the coagulant in the water treatment system where sludge is produced, mixing the sludge in a mixing tank with acid to produce waste solids and acidified solids, wherein the acid is one or more of new acid or recovered acid, and wherein the coagulant is one of an aluminum coagulant or an iron coagulant; and
in a combined membrane treatment tank having cation exchange membranes and anion exchange membranes,
(1) recovering aluminum or iron ions as they diffuse across the cation exchange membranes into an acid solution cell and react with a sulfuric acid solution or a hydrochloric acid solution to form recovered coagulant, and
(2) recovering anions as they diffuse across the anion exchange membranes into a water cell to form the recovered acid.

11. The process of claim 10, wherein the aluminum is trivalent aluminum ions, and wherein the recovered coagulant is alum.

12. The process of claim 11, wherein the trivalent aluminum ions diffuse across the cation exchange membranes and react with the sulfuric acid solution to form the recovered coagulant of alum.

13. The process of claim 12, wherein the recovered coagulant is reused in the water treatment system as the coagulant.

14. The process of claim 10, wherein a diffusion rate of the aluminum or iron ions across the cation exchange membranes is equal to or greater than the diffusion rate of the anions across the anion exchange membranes.

15. The process of claim 10, wherein the anions are one or more of sulfates or chlorides that react with water in the water cell to form sulfuric acid or hydrochloric acid.

16. A system for simultaneously recovering coagulant and acid in a water treatment system, the system comprising:
a mixing tank that receives and mixes sludge from the water treatment system, and a first acid stream to form acidified solids and waste solids, the first acid stream being recovered acid or new acid;
a combined membrane treatment tank that receives the acidified solids from the mixing tank, water, and a second acid stream to form the recovered acid and recovered coagulant,
(1) wherein the combined membrane treatment tank is used to simultaneously recover the coagulant from the acidified solids and at least a portion of the first acid stream, and
(2) wherein a diffusion rate of metal cations across cation exchange membranes in the combined membrane treatment tank is equal or greater than the diffusion rate of anions across the anion exchange membranes in the combined membrane treatment tank.

17. The system of claim 16, further comprising a clarifier sludge tank that clarifies the sludge from the water treatment system to form clarified sludge and a thickening tank that thickens the clarified sludge by removing a portion of water in the clarified sludge to form a thickened sludge that flows into the mixing tank.

18. The system of claim 16, wherein the metal cations are one of trivalent aluminum ions or iron ions.

19. The system of claim 16, wherein the anions are one of sulfates or chlorides that react with water to form the recovered acid.

20. The system of claim 16, wherein the metal cations diffuse across the cation exchange membranes into an acid solution such that the metal cations react with the second acid stream in the acid solution to form the recovered coagulant.
